(19) United States
(12) Patent Application Publication
(10) Pub. No.: US 2007/0009881 A1
(43) Pub. Date: Jan. 11, 2007

(54) Perfusion circuit

(76) Inventors: Joachim Arzt, Reichenbach (DE); Albrecht Gnuechtel, Mannheim (DE); Christine Thiele, Dresden (DE); Michael Schoen, Leipzig (DE)

Correspondence Address: BOHAN, MATHERS & ASSOCIATES, LLC, PO BOX 17707, PORTLAND, ME, 04112-8707, US

(21) Appl. No.: 10/570,920

(22) PCT Filed: Sep. 2, 2004
(86) PCT No.: PCT/DE04/01945

§ 371 Date: May 19, 2006

(30) Foreign Application Priority Data
Sep. 3, 2003 (DE) 10340487.2

(51) Int. Cl. A01N 1/02

(52) U.S. Cl. 435/1.2; 435/284.1

(57) ABSTRACT

A perfusion system for the extracorporeal preservation of vitality or regeneration of organs, limbs or tissue lobes for use in transplant surgery, extracorporeal support of the liver, or for biochemical or pharmacological study of isolated organs. The system comprises an organ perfusion chamber filled with dialysate as the storage fluid and equipped with a temperature control device. An impermeable protective cover in the organ perfusion chamber is surrounded by the storage fluid. The cover receives the isolated organ and protects it from the storage fluid. The circulation system for maintaining vitality of the isolated organ includes a perfusate circulation system, an oxygenator, a dialyzer, and a dialysate circulation system. The perfusate circulation system comprises one or two pumps and two valves for independently dosing the perfusate partial flows and setting the mixing ratio, and not more than two reservoirs for collecting the perfusate.

The invention relates to a perfusion circulation system or circuit for extracorporeally preserving vitality of or regenerating organs, limbs or tissue lobes (hereinafter referred to as organs) for use in transplant surgery or the extracorporeal support of the liver or for biochemical or pharmacological examination in extracorporeal organs.

Devices for the perfusion of isolated organs are of prior art.

Hypothermic preservation at temperatures between 0 and 4° C. is practised at a large scale. With different preservation solutions, preservation times of over 24 hours can be achieved. However, organ regeneration is not possible with this standard method. Hypothermic preservation is not a suitable method of preservation of organs from non heart beating donors.

Normothermic liver perfusion devices are used for vital-state maintenance or regeneration of organs from non heart beating donors. Normothermic perfusion is also a method for vital-state maintenance of organs of decerebrate donors.

According to DE 44 07 863 C2, the perfusion device comprises two separate circuits, one perfusate and one dialysate circuit, assigned to which is an oxygenator, and a device for irrigation cleaning. The latter is performed in-between, every time after stopping the two other circuits. Assigned to each circuit is a pump. The working temperature according to the proposal is 21° C. In the animal experiment, the preserved front leg of a pig was lying in the spray jet of the perfusate inside a chamber that had been closed airtight.

According to WO 99/15011 A1, the perfusate is treated, i.e. maintained at temperature, oxygenated and dialyzed, centrally. From the main line, it is distributed by a pump to the number of lines required for perfusing the organ. In the preservation of livers, lines supplying the Vena portae and the Arteria hepatica are provided. Thus, either receives the same perfusate enriched with oxygen, with the volume of flow determined by the flow resistance of the liver vessels. The liver lies in a perfusion chamber. The perfusate leaving the Vena cava flows through the liver and into the chamber and from there in a central collection vessel.

In the early 1980s, Neuhaus, P. developed a close and pressure oscillating liver perfusion (Extrakorporale Leberperfusion: Entwicklung und Erprobung eines neuen Modells-Habilitationsschrift. 1982; Medizinische Hochschule Hannover) in which the liver protected by a plastic cover is placed in a closed organ perfusion chamber that is filled with fluid and to which cyclical pressure fluctuations simulating respiratory excursions are applied from outside. The vascular lumina follow the artificial intraabdominal pressure fluctuations. The result of the perfusion can clearly be improved by this perfusion method, particularly in the lobular periphery. Besides, underperfusion of large areas which due to the size and related weight of a pig's liver with common placement on the underside, is avoided.

Schon, M. R. uses such a fluid-filled, closed perfusion chamber with cyclic pressure fluctuation in a perfusion device for normothermic extracorporeal liver perfusion (Transplantation von Lebern nicht-herzschlagender Spender im Schweineleber-Transplantationsmodell-Habilitationsschrift 1999. Humboldt Universität zu Berlin). Water heated to about 37° C. in an external heat exchanger flows through the organ perfusion chamber. This circuit is needed in addition to the perfusion circuit. As usual, the perfusate is collected after passage through the organ, then it is transferred and maintained at temperature. A part of it is oxygenated and dialyzed. About one half of this partial flow is returned directly to the Arteria hepatica and the other one half is mixed with the remaining perfusate flow by a pump arrangement. The mixed perfusate is fed to the Vena portae via another heat exchanger.

Each partial circuit contains at last one pump, one heat exchanger and at least one reservoir to obtain a physiological dosage and treatment of the perfusate partial flows in the Vena portae, on the one hand, and the Arteria hepatitis, on the other hand. With this arrangement, the author was able to provide experimental evidence that the normothermic preservation is an alternative to cold preservation both in general and also preferentially for the use of livers from non heart beating donors.

This circulation system comes close to the physiological supply of the organ; the required high level of technical equipment, however, seems to be impedimentary to a further approximation to the natural physiology.

The perfusion device described in WO 00/60936 A1 also seems to require a high level of equipment. In addition, the organ (e. g., the liver) regulates itself (autoregulation) during the inflow and outflow of the perfusate, which fails to work optimally in an extracorporeal environment.

It is the object of the invention to come as near as never before to a natural physiological supply of the organ and to maintain this standard reliably. To avoid damage to the isolated organ, it is particularly necessary to exclude or at least reduced damage to the blood by the apparatuses in a sustained way as far as possible and to avoid side effects which are uncontrollable due to the long residence time of the oxygenated perfusate and have a negative affect on the vital-state maintenance of the extracorporeal organ.

According to the invention, this object is attained by the distinguishing features of the main claim. Other useful embodiments of the invention result from the following claims.

The invention is based on the conception to avoid a detrimental effect of apparatuses, foreign surfaces and auxiliary devices. Following another conception of the invention, the residence time of the oxygenated perfusate is kept short. Surprisingly, it was found that a lower level of technological expenditure according to the invention helps reduce damage to the blood and thereby further adapt the vital state maintaining circuit to the natural physiological conditions.

According to the invention, this objective is attained in that in a perfusion device for the extracorporeal preservation of organs with a perfusion circuit and a dialysate circuit the dialysate passes through the organ perfusion chamber. During this process, the organ is protected by a plastic cover. The dialysate circulates through the dialyzer. Although, in doing so, the concentration of contaminant in the dialysate can increase, it remains within controllable limits. Due to the size of the organ perfusion chamber, the temperature remains relatively constant. Its temperature can be maintained by a controllable, large-area temperature arrangement of relatively low output. The temperature which is simply adjusted in this manner can also be used for maintaining the temperature of the perfusate. For this, in one preferred embodiment of the invention, the dialysate is connected to at least one heat exchanger as a source of heat and cold, respectively.

Furthermore, the invention is based on the conception to provide, in the perfusion circuit, at least one control valve for setting the ratio of the part flows through, and to the at least one inlet of, the organ to be preserved.

The mixing of the perfusate is performed reliably in one of the two reservoirs. The circuit is controlled digitally by a process computer. The simple design and the clearness of the vital-state maintaining circuit according to the invention makes manual control, particularly in emergency operation, possible in advantageous manner, which can also be performed reliably.

With the arrangement according to the invention, at least one more pump and circuit, respectively, is saved in comparison with the prior art.

For biochemical and pharmacological examinations, in particular, devices according to the invention are coupled and connected in parallel. Thereby, essential technical apparatuses, namely pumps, valves and reservoirs, and the medical apparatuses, namely the dialyzer and/or the oxygenator, are used jointly by the coupled individual components. With this coupled arrangement, an equivalent test arrangement is attained.

The following examples of embodiments show how according to the invention an independent dosing of different perfusates to more than one organ inlet can be attained.

With reference to the accompanying drawings, one example of the embodiment of the invention will now be described in detail.

Herein,

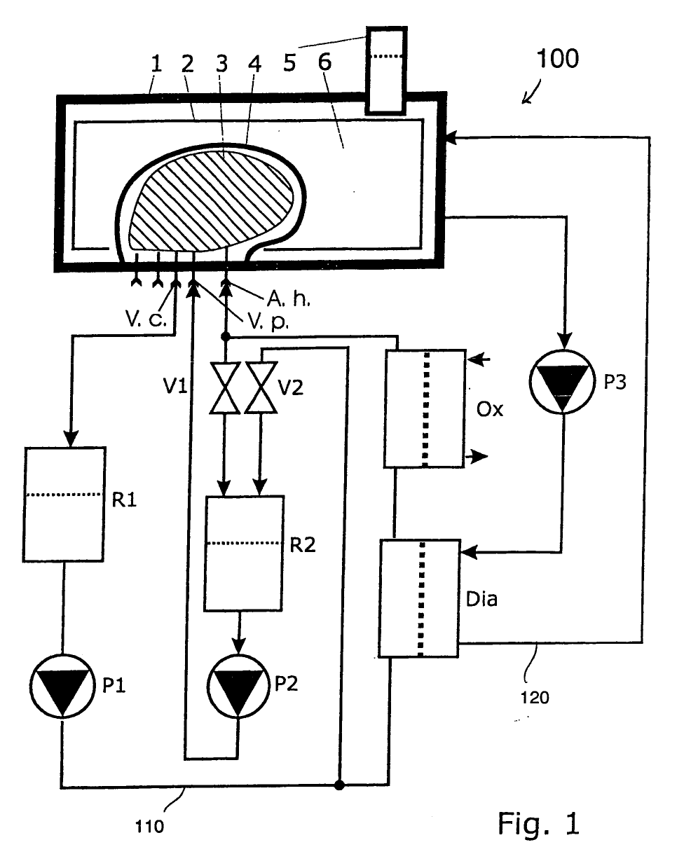

FIG. 1 schematically depicts the arrangement, in particular with reference to claim 4, by the example of a liver;

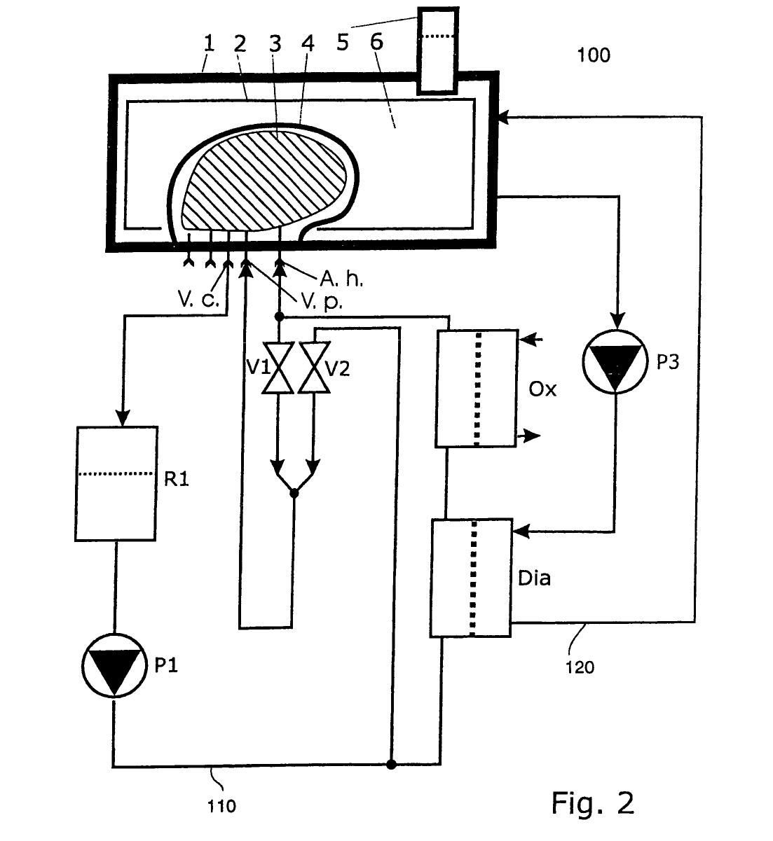

FIG. 2 schematically depicts the arrangement, in particular with reference to claim 5, by the example of a liver;

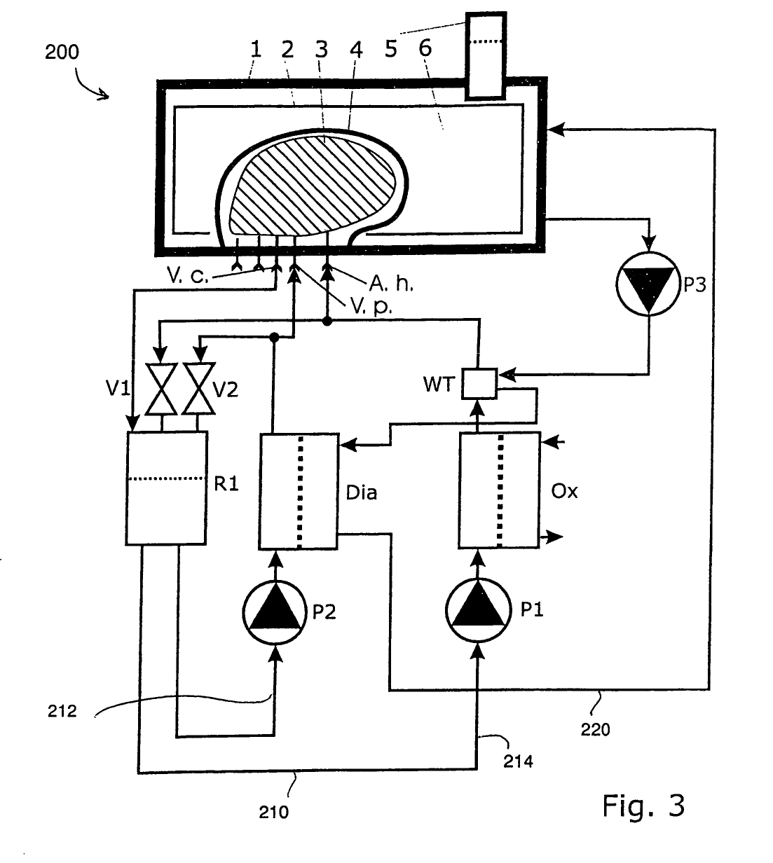

FIG. 3 schematically depicts the arrangement, in particular with reference to claim 6, by the example of a liver;

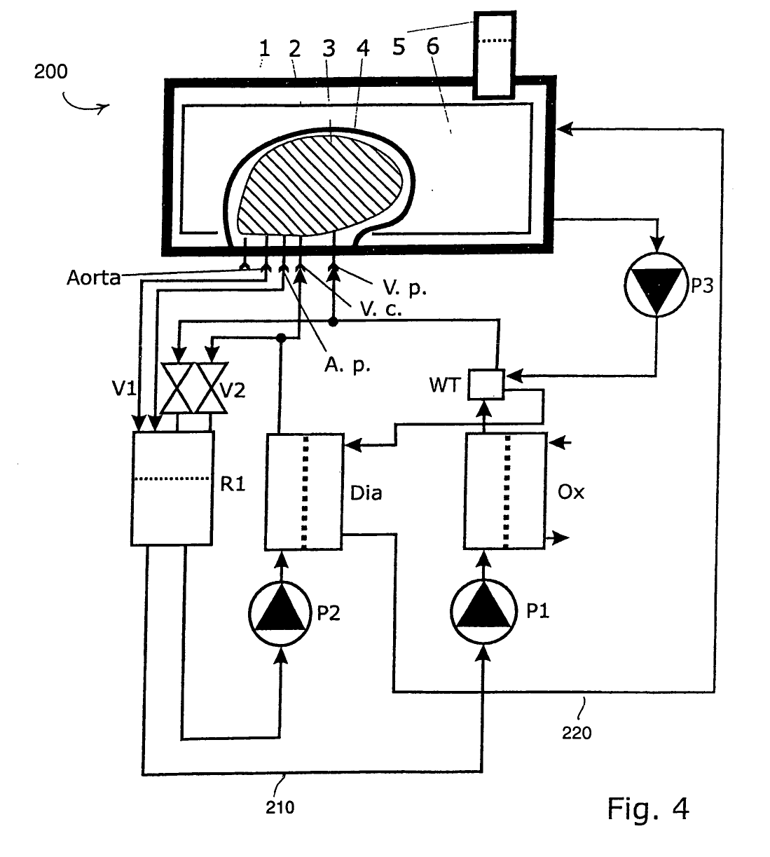

FIG. 4 schematically depicts the arrangement, in particular with reference to claim 6, by the example of a heart;

In all figures, organ perfusion chamber 1 is sectioned at the level of organ 3 and depicted as top view.

Reference will now be made to FIG. 1.

An isolated organ 3 that is to be preserved lies—protected by protective cover 4—in a box-shaped organ perfusion chamber 1. A controllable temperature device 2 is executed as heating mat and is disposed at the bottom of organ perfusion chamber 1. Organ perfusion chamber 1 is completely filled with dialysate 6 and serves as dialysate reservoir. Following is a dialysate circuit with dialyzer Dia, driven by pump P3, for cleaning the perfusate. Flowing through dialyzer Dia, the perfusate is not only cleaned as intended, its temperature is also maintained. In the example of the embodiment, organ 3 is a liver. It has the two inlets Vena portae V.p. and Arteria hepatica A.h. and the outlet Vena cava V.c., through which the perfusate enters and leaves, respectively, as described below. Further secondary outlets, for example, for the bile, are not shown. As described by Neuhaus, organ perfusion chamber 1 is subjected to cyclical pressure fluctuations to simulate an intraabdominal breathing excursion.

The perfusate leaving the Vena cava V.c. is collected in reservoir R1 and pumped by pump P1. One part flows in a second reservoir R2 through valve V2. The other part passes through dialyzer Dia and an oxygenator Ox. The dialyzed, oxygenated and temperature-maintained partial flow of the perfusate is directly available at the inlet of Arteria hepatica A.h., for one, and at another control valve V1, for another. The perfusate partial flows passing valves V1 and V2 mix in a reservoir R2.

The mixed perfusate is pumped in Vena portae V.p. by pump P2. With the two pumps P1 and P2, control valves V1 and V2 and reservoir R2, an independent dosing of the partial flows through the vessels of the organ, liver vessels in this case, is attained.

By way of example, riser 5 has been placed vertically on perfusion chamber 1 as level indication means. In FIG. 1 and the two other figures, this riser has been turned through 90° in the plane of the sheet.

Several measuring probes pick up characteristics and parameters of the circuit, for example, filling level, pressure, temperature and enable the processing of these signals for an indicating device or a digital process control.

Reference will now be made to FIG. 2.

In this version, reservoir R2 and pump P2 have been omitted in comparison with the previous example of an embodiment. The mixing of the perfusate for Vena portae V.p. occurs through a Y-connector, the supply lines to the organ.

With reference to FIG. 3, a third embodiment again does not need reservoir R2. The partial flows flowing through valves V1 and V2 collect in reservoir R1. Like in the first embodiment with reference to FIG. 1, this version has reservoir R1 as buffer, which also ensures independent dosing of the partial flows.

In contrast to the two first embodiments, oxygenator Ox and dialyzer Dia are disposed in separate branches. As before, the temperature of the perfusate is maintained in the dialyzer branch. To maintain the temperature of the perfusate also on passage through oxygenator Ox, heat exchanger WT is provided. Heat exchanger WT is connected to the dialysate circuit. In another form of this embodiment, valve V2 can be dispensed with without loss of the physiological supply of extracorporeal organ 3.

A fourth embodiment with reference to FIG. 4 is designed in analogy to FIG. 3. It depicts as stored extracorporeal organ 3 a heart with Arteria pulmonalis A.p and Vena pulmonalis V.p. as ingoing lines and Vena cava V.c. and Aorta as outgoing lines of the perfusate. In addition, a link between Arteria pulmonalis A.p. or the aorta to reservoir R1 is provided.

1-20. (canceled)

21. A perfusion system for preserving vitality or regeneration of an isolated organ, said system comprising:
an organ perfusion chamber;
a temperature control device;
storage fluid filled in said organ perfusion chamber, said storage fluid being dialysate;
a protective cover within said organ perfusion chamber for receiving an isolated organ, wherein said protective cover is surrounded by said storage fluid;
a dialysate circuit for circulating dialysate to and from said organ perfusion chamber, said dialysate circuit including a dialyzer, an oxygenator, and a dialysate circuit pump;
a perfusate circuit that includes an outflow perfusate line from said organ perfusion chamber to a reservoir, a perfusate circuit pump for pumping said perfusate, a first perfusate partial flow, a second perfusate partial flow that transports a portion of said perfusate through said oxygenator and said dialyzer in said dialysate circuit to obtain an oxygenated perfusate, and a mixing device for mixing said first perfusate partial flow and said second perfusate partial flow into a mixed perfusate, and a perfusate inflow line that transports said mixed perfusate and/or oxygenated perfusate into an isolated organ stored in said organ perfusion chamber.

22. The perfusion system of claim 21, wherein said reservoir is a single reservoir in said perfusate circuit and said perfusate circuit pump is a single perfusate circuit pump in said perfusate circuit, and wherein said mixing device is a Y-connector that receives perfusate from said first perfusate partial flow and from said second perfusate partial flow and transports said mixed perfusate into said perfusate inflow line.

23. The perfusion system of claim 21, wherein said reservoir is a first reservoir and said mixing device is a second reservoir in said perfusate circuit, wherein said first perfusate partial flow and said second perfusate partial flow are mixed in said second reservoir to said mixed perfusate.

24. The perfusion circuit of claim 23, wherein said perfusate circuit pump is a first perfusate circuit pump, wherein said perfusate circuit includes a second perfusate circuit pump that pumps said mixed perfusate into said perfusate inflow line.

25. The perfusion circuit of claim 21, further comprising one or more control valves for regulating flow of said first perfusate partial flow and said second perfusate partial flow in said perfusate circuit.

26. The perfusion circuit of claim 25, wherein said perfusate inflow line includes a first perfusate inflow line for transporting mixed perfusate and a second perfusate inflow line for transporting oxygenated perfusate, and wherein said one or more control valves enable an independent dosing of mixed perfusate into said first perfusate inflow line and of said oxygenated perfusate into said second inflow line.

27. The perfusion circuit of claim 21, further comprising a fluid-level indicator for reporting a fluid level of said storage fluid in said organ perfusion chamber.

28. The perfusion circuit of claim 21, further comprising a temperature control device for maintaining a temperature of said storage fluid in said organ perfusion chamber.

29. The perfusion circuit of claim 28, wherein said temperature control device is a heating mat disposed in said organ perfusion chamber.

30. The perfusion system of claim 21, wherein said isolated organ is a liver and said perfusate outflow line is connectable to said vena cava and said perfusate inflow line is connectable to said vena portae.

31. A perfusion system for preserving vitality or regeneration of an isolated organ, said system comprising:
an organ perfusion chamber;
a temperature control device;
storage fluid filled in said organ perfusion chamber, said storage fluid being dialysate;
a protective cover within said organ perfusion chamber for receiving an isolated organ, wherein said protective cover is surrounded by said storage fluid;
a dialysate circulation system for transporting dialysate to and from said organ perfusion chamber, said dialysate circulation system including a dialysate circulation pump;
a perfusate circulation system that includes an outflow perfusate line from said organ perfusion chamber to a single perfusate circulation reservoir, a first perfusate circulation pump for pumping a first perfusate partial flow through a dialyzer in said perfusate circulation system, a second perfusate circulation pump for pumping a second perfusate partial flow through an oxygenator and a heat exchanger in said perfusate circulation system, a mixing device for mixing said first perfusate partial flow and at least a portion of said second perfusate partial flow into a mixed perfusate, and a perfusate inflow line for transporting perfusate from said perfusate circulation system into an isolated organ stored in said organ perfusion chamber.

32. The perfusion system of claim 31, wherein said dialysate from said dialysate circulation system flows through said heat exchanger and into said perfusate circulation system, thereby exchanging heat with said first perfusate partial flow and said second perfusate partial flow

33. The perfusion system of claim 31, further including a control valve for controlling flow from said perfusate inflow line into said single perfusate circulation reservoir and, as needed, into said isolated organ stored in said organ perfusion chamber.

34. The perfusion system of claim 31, wherein said perfusate inflow line includes one or more inflows that are connectible to inflow paths on said isolated organ.

35. The perfusion system of claim 31, wherein said perfusate outflow line includes one or more outflows that are connectible to outflow paths on said isolated organ.

36. The perfusion system of claim 31, wherein said temperature control device is a heating mat that is disposed within said organ perfusion chamber to maintain said storage fluid to a desired temperature.

37. A method of maintaining perfusate used in extracorporeal storage of an organ, said method comprising the steps of:
(a) filling an organ perfusion chamber with a storage fluid that is a dialysate
(b) maintaining said dialysate in said organ perfusion chamber to a desired temperature;
(b) providing a dialysate circulation system that receives said dialysate from said organ perfusion chamber;
(c) providing a perfusate circulation system that divides said perfusate in at least a first perfusate partial flow and second perfusate partial flow;
(d) transporting perfusate in said second perfusate partial flow through said dialysate circulationsystem, thereby effecting a heat exchange between said dialysate and said perfusate in said second perfusate partial flow;
(e) mixing said second perfusate partial flow and said first perfusate partial flow to a mixed perfusate;
(f) transporting said mixed perfusate to said organ in said organ perfusion chamber.

38. The method of claim 37, said method further comprising the steps of:
(g) providing a flow control valve between a reservoir in said perfusate circuit and a perfusate circuit inflow line for controlling a dosing of first perfusate partial flow and second perfusate partial flow.
